(19) United States
(12) Patent Application Publication
(10) Pub. No.: US 2026/0103575 A1
(43) Pub. Date: Apr. 16, 2026

(54) POLYMER COMPOSITION FOR SHEETS AND THERMOFORMED OBJECTS

(71) Applicant: SABIC GLOBAL TECHNOLOGIES B.V., Bergen op Zoom (NL)

(72) Inventors: Li Yuan, Shanghai (CN); Maria Soliman, Selfkant (DE); Weisong Gao, Shanghai (CN); You Jun Wu, Shanghai (CN); Teck Fui Chong, Johor Bahru (MY); Lanti Yang, Noord-Brabant (NL)

(21) Appl. No.: 19/117,212

(22) PCT Filed: Sep. 28, 2023
(86) PCT No.: PCT/EP2023/076900

§ 371 Date: Mar. 31, 2025

(30) Foreign Application Priority Data
Oct. 4, 2022 (EP) 22199534.3

(51) Int. Cl. C08J 5/18; B29C 51/00; B29K 23/00; B32B 27/08; B32B 27/32; C08L 23/12

(52) U.S. Cl. CPC C08J 5/18; B32B 27/08; B32B 27/32; C08L 23/12; B29C 51/002; B29K 2023/12; C08J 2300/22; C08J 2323/12; C08J 2423/08; C08L 2205/025

(57) ABSTRACT

A polymer composition including:
a. a propylene-based homopolymer matrix; and
b. ethylene-based copolymer domains dispersed in the matrix
   wherein the composition includes ≥80.0 and ≤98.0 wt % of the propylene-based homopolymer, and ≥2.0 and ≤20.0 wt % of the ethylene-based copolymer, with regard to the total weight of the polymer composition.

Such polymer composition allows for the manufacture of sheets that may be used in thermoforming processes to manufacture objects having good optical properties, reflected by low haze, wherein reduced sagging occurs during processing.

### CROSS REFERENCE TO RELATED APPLICATIONS

This application is a National Stage application of PCT/EP2023/076900, filed Sep. 28, 2023, which claims the benefit of European Application No. 22199534.3, filed Oct. 4, 2022, both of which are incorporated by reference in their entirety herein.

### BACKGROUND

The present invention relates to a polymer composition for the production of sheets. The invention further relates to sheets comprising the polymer composition, and to thermoformed objects thereof.

Thermoforming is one of the most frequently used thermoplastic shaping techniques, in particular in the field of production of packaging applications. Thermoforming allows for production of shaped objects, such as certain packaging containers, via an easy, low cost, and high speed manufacturing process, resulting in shaped objects having desirably high performance.

Typically, thermoforming processes are performed by subjecting a film or sheet of a thermoformable material composition to a certain temperature at which it becomes sufficiently softened or pliable, upon which the pliable sheet is forced into a mould of the desired shape by application of either a vacuum to draw the pliable sheet into the mould, by pushing the sheet into the mould by a counterpart, or by a combination of both.

By so, one can manufacture shapes such as containers and cups for a wide variety of applications. Ongoing developments relating to the requirements for the shaped objects continue to drive a need to development of the materials that are employed in the sheets that are suitable to be used for such newly developed shapes and the shaping processes by which they are manufactured. Particularly, an ongoing drive exists to reduce the weight of the objects, i.e. the quantity of material that is used for the manufacture of such object. There are a variety of reasons why such weight reduction is considered desirable. For example, when the sheet that is the be used for the thermoforming process is thinner, less energy is required to bring the sheet into a thermoformable state; which is beneficial for both the energy consumption of the process as well as for the speed at which the process may be operated. Further, a reduction of the quantity of material used is also beneficial as this means that less waste is generated after the arrival of the object at the end of its service life.

A further driver in the field of thermoforming is to increase the use of polyolefin materials. Polyolefin materials make up the majority portion of thermoplastic materials presently used globally, and thus also constitute the major fraction of plastic materials that end up in recycle streams. Since recycle streams are easier to process when the composition of materials therein is as uniform as possible, it is desirable to increase the fraction of polyolefin materials therein. In view thereof, it is desirable for thermoformed packaging objects to be manufactured out of a polyolefin material formulation.

A particular type of polyolefin material that may be used in thermoforming processes is polypropylene. In particular, homopolymers of propylene are suitable for use in thermoforming processes to manufacture thin-walled packaging objects. In the context of the present invention, such homopolymers of propylene are also referred to as hPP. Sheets made out of hPP provide a desirable stiffness, which is desirable in both the application as during the manufacturing of the object, as the sheet.

Besides the unsatisfactory physical performances of hPP sheet, the processability of it is also an issue in the process involving uniaxial extension flow, such as thermoforming. In the process of thermoforming, the sheet must be heated to the point where the material can endure plastic deformation without significant thinning in one portion and not thinning in another thus resulting the discontinuity on production due to sheet broken and high rate of unqualified product with unacceptable thickness variation. This process performance in the thermoforming is called sagging resistance and pure hPP sheets typically have poor sagging resistance.

There are however also further properties of pure hPP that need to be mitigated in order to optimize the manufacturing processes of thin-wall thermoformed objects, as well as to ensure or improve the quality of such objects. Particularly, the toughness of the hPP typically requires improvement for the given application.

According to the art, improvement thereof have been attempted by addition of a fraction of a propylene-based elastomer material to the hPP composition. Although this may result in a limited improvement of the toughness of the material, it negatively affects other properties, notably the optical properties.

Accordingly, there continues to exist a need for improvement of hPP material formulations for use in thermoforming application, having improved toughness and optical properties.

### SUMMARY

This is now achieved according to the present invention by a polymer composition comprising:
a. a propylene-based homopolymer matrix; and
b. ethylene-based copolymer domains dispersed in the matrix
   wherein the composition comprises ≥80.0 and ≤98.0 wt % of the propylene-based homopolymer, and ≥2.0 and ≤20.0 wt % of the ethylene-based copolymer, with regard to the total weight of the polymer composition.

### DETAILED DESCRIPTION

Such polymer composition allows for the manufacture of sheets that may be used in thermoforming processes to manufacture objects having good optical properties, reflected by low haze, wherein reduced sagging occurs during processing.

For example, the composition may comprise ≥95.0 wt % of the sum of the weight of the propylene-based homopolymer and the ethylene-based copolymer, with regard to the total weight of the polymer composition, preferably ≥98.0 wt %. Alternatively, the composition may consist the propylene-based homopolymer and the ethylene-based copolymer. For the avoidance of doubt, by ‘consist essentially of’ herein is meant that the composition comprises no other thermoplastic polymer material other than the propylene-based homopolymer and the ethylene-based copolymer, except for minor amounts of thermoplastic polymer that may be present as carriers in masterbatch formulations of additives that may be present in the composition. For example, the composition may consist of the propylene-based homopolymer, the ethylene-based copolymer, and additives. For example, the composition may consist of the propylene-based homopolymer, the ethylene-based copolymer, and ≤1.0 wt % additives, with regard to the total weight of the polymer composition. It is preferred that the composition comprises no other thermoplastic polymer materials other than the propylene-based homopolymer and the ethylene-based copolymer.

In the polymer composition, it is preferred that the ethylene-based copolymer is present in the matrix in the shape of domains having an average aspect ratio of ≥4.0.

The average aspect ratio may be determined via Atomic Force Microscopy (AFM) using the method as set out in the section below describing the examples in the present description.

The ethylene-based copolymer may for example comprise ≥70.0 wt % of polymer units derived from ethylene, with regard to the total weight of the ethylene-based copolymer, and polymer units derived from one or more α-olefin selected from 1-butene, 1-pentene, 4-methyl-1-pentene, 1-hexene, and 1-octene, preferably 1-octene. Preferably, the ethylene-based copolymer comprises polymer units derived from ethylene and polymer units derived from 1-butene, 1-hexene or 1-octene, preferably 1-octene. More preferably, the ethylene-based copolymer comprises ≥70.0 wt % of polymer units derived from ethylene, with regard to the total weight of the ethylene-based copolymer, and polymer units derived from 1-octene.

The ethylene-based copolymer may for example have a density of ≥855 and ≤925 kg/m³, preferably of ≥870 and ≤910 kg/m³, more preferably of ≥890 and ≤910 kg/m³, wherein the density is determined in accordance with ASTM D1505 (2010).

The ethylene-based copolymer may for example have a melt mass-flow rate as determined at 190° C. under a load of 2.16 kg, in accordance with ASTM D1238 (2013), of ≥0.5 and ≤10.0 g/10 min, preferably of ≥2.0 and ≤5.0 g/10 min.

The ethylene-based copolymer may for example have a molecular weight distribution M_{w}/Mₙ of ≥2.0 and ≤4.0, preferably of ≥2.5 and ≤3.5, wherein M_{w} is the weight-average molecular weight and Mₙ is the number-average molecular weight, both determined in accordance with ASTM D6474 (2012).

The ethylene-based copolymer may for example have a fraction eluted in a-TREF analysis at ≤30° C. of ≤10.0 wt %, preferably of ≤5.0 wt %, with regard to the total weight of the ethylene-based copolymer.

The ethylene-based copolymer may for example have a fraction eluted in a-TREF analysis between 3° and 94° C. of ≥90.0 wt %, preferably of ≥95.0 wt %, with regard to the total weight of the ethylene-based copolymer.

The ethylene-based copolymer may for example have a comonomer content of ≥15.0 wt %, preferably of ≥15.0 wt % and ≤30.0 wt %, with regard to the total weight of the ethylene-based polymer, preferably wherein the comonomer is 1-octene.

The ethylene-based copolymer may for example have a fraction eluted in a-TREF analysis at ≤30° C. of ≤10.0 wt %, preferably of ≤5.0 wt %, with regard to the total weight of the ethylene-based copolymer, and a fraction eluted in a-TREF analysis between 3° and 94° C. of ≥90.0 wt %, preferably of ≥95.0 wt %, with regard to the total weight of the ethylene-based copolymer.

The ethylene-based copolymer may for example have:
a. a molecular weight distribution M_{w}/Mₙ of ≥2.0 and ≤4.0, preferably of ≥2.5 and ≤3.5, wherein M_{w} is the weight-average molecular weight and Mₙ is the number-average molecular weight, both determined in accordance with ASTM D6474 (2012);
b. a fraction eluted in a-TREF analysis at ≤30° C. of ≤10.0 wt %, preferably of ≤5.0 wt %, with regard to the total weight of the ethylene-based copolymer;
c. a fraction eluted in a-TREF analysis between 3° and 94° C. of ≥90.0 wt %, preferably of ≥95.0 wt %, with regard to the total weight of the ethylene-based copolymer; and
d. a comonomer content of ≥15.0 wt %, preferably of ≥15.0 wt % and ≤30.0 wt %, with regard to the total weight of the ethylene-based polymer, preferably wherein the comonomer is 1-octene.

The propylene-based homopolymer may for example have a density of ≥880 and ≤920 kg/m³, preferably of ≥890 and ≤910 kg/m³, more preferably of ≥900 and ≤910 kg/m³, wherein the density is determined in accordance with ASTM D793 (2013).

The propylene-based homopolymer may for example have a melt mass-flow rate of ≥0.5 and ≤10.0 g/10 min, preferably of ≥2.0 and ≤5.0 g/10 min, as determined at 230° C. under a load of 2.16 kg, in accordance with ASTM D1238 (2013).

The invention also relates to a sheet comprising the polymer composition according to the invention, preferably having a thickness of ≥100 and ≤2000 μm. The sheet may for example be a multi-layer sheet comprising at least one layer, preferably a multi-layer sheet comprising at least three layers wherein the multi-layer sheet comprises or consists of the polymer composition in its core layer.

The invention also relates to a process for producing a thermoformed object, involving providing a sheet according to the invention, heating the sheet to a temperature of ≥140° C. and ≤165° C., preferably ≥145° C. and ≤160° C., and subjecting the sheet to a thermoforming process.

The invention also relates to a thermoformed object comprising the polymer composition the invention.

The invention also relates to the use of a polymer composition comprising:
a propylene-based homopolymer matrix; and
ethylene-based copolymer domains dispersed in the matrix
wherein the composition comprises ≥80.0 and ≤98.0 wt % of the propylene-based homopolymer, and ≥2.0 and ≤20.0 wt % of the ethylene-based copolymer, with regard to the total weight of the polymer composition;
for reduction of sagging in thermoforming processing.

Analytical temperature rising elution fractionation, also referred to as a-TREF, may be carried out using a Polymer Char Crystaf-TREF 300 equipped with stainless steel columns having a length of 15 cm and an internal diameter of 7.8 mm, with a solution containing 4 mg/ml of sample prepared in 1,2-dichlorobenzene stabilised with 1 g/l Topanol CA (1,1,3-tri(3-tert-butyl-4-hydroxy-6-methylphenyl)butane) and 1 g/l Irgafos 168 (tri(2,4-di-tert-butylphenyl)phosphite) at a temperature of 150° C. for 1 hour. The solution may be further stabilised for 45 minutes at 95° C. under continuous stirring at 200 rpm before analyses. For analyses, the solution was crystallised from 95° C. to 30° C. using a cooling rate of 0.1° C./min. Elution may be performed with a heating rate of 1° C./min from 30° C. to 140° C. The set-up may be cleaned at 150° C. The sample injection volume may be 300 μl, and the pump flow rate during elution 0.5 ml/min. The volume between the column and the detector may be 313 μl. The fraction that is eluted at a temperature of ≤30.0° C. may in the context of the present invention be calculated by subtracting the sum of the fraction eluted >30.0° C. from 100%, thus the total of the fraction eluted≤30.0° C., and the fraction eluted >30.0° C. to add up to 100.0 wt %.

Particularly, a-TREF may be carried out using a Polymer Char Crystaf-TREF 300 using a solution containing 4 mg/ml of the polymer in 1,2-dichlorobenzene, wherein the solution is stabilised with 1 g/l 1,1,3-tri(3-tert-butyl-4-hydroxy-6-methylphenyl) butane and 1 g/l tri(2,4-di-tert-butylphenyl) phosphite) at a temperature of 150° C. for 1 hour, and further stabilised for 45 minutes at 95° C. under continuous stirring at 200 rpm, wherein the prior to analyses the solution is crystallised from 95° C. to 30° C. using a cooling rate of 0.1° C./min, and elution is performed at a heating rate of 1° C./min from 30° C. to 140° C., and wherein the equipment has been cleaned at 150° C.

The invention will now be illustrated by the following non-limiting examples.

### Materials

The below materials were used in the examples to demonstrate the invention.

| | |
|---|---|
| hPP | SABIC 522K, a polypropylene homopolymer having an MFR of |
| | 3.0 g/10 min at 230° C./2.16 kg, and a density of 905 kg/m³, |
| | obtainable from SABIC |
| PE1 | Supreme 051, an ethylene-based copolymer having an MFR of |
| | 0.8 g/10 min at 190° C./2.16 kg, and a density of 905 kg/m³, |
| | obtainable from SK Chemical |
| PE2 | Cohere 8402, an ethylene-based copolymer having an MFR of |
| | 3.5 g/10 min at 190° C./2.16 kg, and a density of 902 kg/m³, |
| | obtainable from SABIC |
| PP3 | Vistamaxx 6102, a propylene-based copolymer having an MFR |
| | 1.4 g/10 min at 190° C./2.16 kg and a density of 862 kg/m³, |
| | obtainable from ExxonMobil |

### Production of Sheets

Using the above-listed materials, several sheets were fabricated. The sheets consisted of a polymer composition as listed in the table below. The blended formulations as in examples 2-7 were produced by dry blending of the polymer pellets prior to feeding the composition to the hopper of the extruder.

| Example | Polymer composition |
|---|---|
| 1 | 100% hPP |
| 2 | 95% hPP, 5% PP3 |
| 3 | 90% hPP, 10% PP3 |
| 4 | 95% hPP, 5% PE1 |
| 5 | 90% hPP, 10% PE1 |
| 6 | 95% hPP, 5% PE2 |
| 7 | 90% hPP, 10% PE2 |

The sheets were produced using a 3-layer Randcastle calandering extrusion line equipped with three extruders, however only 1 extruder being used. The extruder was equipped with a screw of diameter 14.6 mm and an L/D ratio of 36. The calandering line was equipped with a flat die of die width 160 mm and die gap 0.2-1 mm. The melt temperature for the extruder was 230° C., and the temperature of the primary and secondary chill rolls was 50° C. Both the primary and the secondary chills rolls had polished surfaces with water circulating through them to provide temperature control. The extruder output was 10 kg/h and the pull speed was 3 m/min for sheet extrusion. The sheets obtained had a dimension of 0.4 mm in thickness and 140 mm in width.

Of each of the sheets, the cross-section morphology was determined via Atomic Force Microscopy (AFM). The sample sheets were cut to size and the cross-section of the sheets in the flow direction of the sheet as extruded was cryo-microtomed at −120° C. using Leica EM UC7 microtoming equipment, to obtain a flat cross-sectional surface. A Diotome diamond knife mounted in a stainless steel holder was used from microtoming the samples. After the cryo-microtoming, the microtomed samples were subjected to AFM measurements directly without further treatment. AFM experiments were performed using a Dimension FastScan AFM system (Dimension FastScan, Bruker, Santa Barbara, USA). Nanoscope Analysis 9.4 software from Bruker was used as computer interface for operation and Nanoscope Analysis 2.0 from Bruker was used for the analysis of the AFM measurements. All AFM measurements were performed at ambient conditions. For morphology characterisation, AFM fastscan tapping mode was used with a frequency of 4 Hz utilising AFM fastscan tips (model Fastscan-A at k: 18 N/m, f: 1400 kHz). The below morphology data relating to the copolymer particles in the homopolymer matrix were obtained from the analysis of the samples.

| Example | 3 | 5 | 7 |
|---|---|---|---|
| Aspect ratio | 2.86 | 6.14 | 6.04 |
| Domain number | 1131 | 544 | 605 |
| Equivalent diameter (μm) | 0.46 | 0.58 | 0.58 |
| Major axis length (μm) | 0.88 | 0.30 | 0.30 |
| Max. free interdistance | 0.67 | 0.95 | 0.93 |
| between particles (μm) | | | |

The sheets that were obtained from these examples were characterised to identify various parameters of the sheets, as shown in the table below.

| Example | Total Energy | Tensile Modulus | Haze | Sagging |
|---|---|---|---|---|
| 1 | 0.56 | 1732 | 16.5 | 20 |
| 2 | 0.62 | 1494 | 17.7 | |
| 3 | 0.71 | 1233 | 22.9 | 15 |
| 4 | 0.61 | 1725 | 16.2 | |
| 5 | 1.14 | 1614 | 16.0 | |
| 6 | 0.70 | 1666 | 14.8 | |
| 7 | 0.92 | 1581 | 14.4 | 13 |

### Wherein:

the total energy is obtained by integration of the load—displacement curve as obtained by subjecting the sample to testing in accordance with ASTM D3763 (2018), expressed in J;
the tensile modulus is determined in accordance ASTM D882 (2009) as secant modulus, expressed in MPa;
the haze is determined in accordance with ASTM D1003 (2013), expressed in %; and
sagging is determined by a method involving providing a sheet sample of 220 mm length and 3.1 mm width, which was clamped at either end so that an effective distance between the clamps of 200 mm occurred. The specimen was placed in an oven at 160° C. for 20 min., after which the sagging distance at the middle point of the specimen was measured.

1. A polymer composition comprising:
a propylene-based homopolymer matrix; and
ethylene-based copolymer domains dispersed in the matrix wherein the composition comprises ≥80.0 and ≤98.0 wt % of the propylene-based homopolymer, and ≥2.0 and ≤20.0 wt % of the ethylene-based copolymer, with regard to the total weight of the polymer composition.

2. The polymer composition according to claim 1, wherein the composition comprises ≥95.0 wt % of the sum of the weight of the propylene-based homopolymer and the ethylene-based copolymer, with regard to the total weight of the polymer composition.

3. The polymer composition according to claim 1, wherein the composition comprises no other thermoplastic polymer materials other than the propylene-based homopolymer and the ethylene-based copolymer.

4. The polymer composition according to claim 1, wherein the ethylene-based copolymer is present in the matrix in the shape of domains having an average aspect ratio of ≥4.0.

5. The polymer composition according to claim 1, wherein the ethylene-based copolymer is a copolymer comprising ≥70.0 wt % of polymer units derived from ethylene, with regard to the total weight of the ethylene-based copolymer, and polymer units derived from one or more α-olefin selected from 1-butene, 1-pentene, 4-methyl-1-pentene, 1-hexene, and 1-octene.

6. The polymer composition according to claim 1, wherein the ethylene-based copolymer has a density of ≥855 and ≤925 kg/m³, wherein the density is determined in accordance with ASTM D1505 (2010).

7. The polymer composition according to claim 1, wherein the ethylene-based copolymer has a melt mass-flow rate as determined at 190° C. under a load of 2.16 kg, in accordance with ASTM D1238 (2013), of ≥0.5 and ≤10.0 g/10 min.

8. The polymer composition according to claim 1, wherein the ethylene-based copolymer has one or more of:
a molecular weight distribution M_{w}/Mₙ of ≥2.0 and ≤4.0, wherein M_{w} is the weight-average molecular weight and Mₙ is the number-average molecular weight, both determined in accordance with ASTM D6474 (2012);
a fraction eluted in a-TREF analysis at ≤30° C. of ≤10.0 wt %, with regard to the total weight of the ethylene-based copolymer;
a fraction eluted in a-TREF analysis between 3° and 94° C. of ≥90.0 wt %, with regard to the total weight of the ethylene-based copolymer; and
a comonomer content of ≥15.0 wt %, with regard to the total weight of the ethylene-based polymer.

9. The polymer composition according to claim 1, wherein the propylene-based homopolymer has a density of ≥880 and ≤920 kg/m³, wherein the density is determined in accordance with ASTM D793 (2013).

10. The polymer composition according to claim 1, wherein the propylene-based homopolymer has a melt mass-flow rate of ≥0.5 and ≤10.0 g/10 min, as determined at 230° C. under a load of 2.16 kg, in accordance with ASTM D1238 (2013).

11. A sheet comprising the polymer composition according to claim 1.

12. The sheet according to claim 11, wherein the sheet is a multi-layer sheet.

13. A process for producing a thermoformed object, involving providing a sheet according to claim 11, heating the sheet to a temperature of ≥140° C. and ≤165° C. and subjecting the sheet to a thermoforming process.

14. A thermoformed object comprising the polymer composition according to claim 1.

15. A method for reduction of sagging in thermoforming processing, the method comprising:
providing a sheet comprising a polymer composition comprising:
a propylene-based homopolymer matrix; and
ethylene-based copolymer domains dispersed in the matrix
wherein the composition comprises ≥80.0 and ≤98.0 wt % of the propylene-based homopolymer, and ≥2.0 and ≤20.0 wt % of the ethylene-based copolymer, with regard to the total weight of the polymer composition;
heating the sheet; and
subjecting the sheet to a thermoforming process.
